(19) United States
(12) Patent Application Publication
(10) Pub. No.: US 2024/0132271 A1
(43) Pub. Date: Apr. 25, 2024

(54) THERMALLY INSULATING BOX INSERTS, AND METHODS OF MAKING AND USING THE SAME

(71) Applicant: COLDKEEPERS, LLC, Thomasville, GA (US)

(72) Inventor: Lionel de Bazelaire de Lesseux, Pinetta, FL (US)

(21) Appl. No.: 18/488,100

(22) Filed: Oct. 16, 2023

Related U.S. Application Data
(60) Provisional application No. 63/418,212, filed on Oct. 21, 2022.

(51) Int. Cl. B65D 81/38

(52) U.S. Cl. CPC B65D 81/3823; B31B 2120/407

(57) ABSTRACT

Thermally insulating box inserts are disclosed. Methods of making and using thermally insulating box inserts are also disclosed.

### FIELD OF THE INVENTION

The present invention is directed to thermally insulating box inserts primarily used in the shipping or storage of goods, foodstuffs, pharmaceuticals, samples, and like items that must be maintained within predetermined temperature ranges for predetermined periods of time in order to ensure the safety and quality of such items. The present invention is further directed to methods of making and using thermally insulating box inserts.

### BACKGROUND

Efforts continue to further develop sustainable, recyclable, preferably repulpable, thermally insulating box inserts that provide superior insulation properties.

### SUMMARY

The present invention addresses some of the difficulties and problems in the art by the discovery of new thermally insulating box inserts.

Accordingly, the present invention is directed to thermally insulating box inserts. In one exemplary embodiment, the thermally insulating box inserts of the present invention comprises a fiber-containing sheet having (i) a front surface, (ii) a rear surface, (iii) a top edge, (iv) a bottom edge, (v) opposite side edges, the opposite side edges being parallel with one another, and (vi) two openings extending from the front surface to the rear surface, and being positioned within an outer periphery of the fiber-containing sheet formed by the top edge, the bottom edge, and the opposite side edges, wherein the fiber-containing sheet is folded to form a box insert profile comprising: (a) a bottom layer comprising outer sheet portions of the fiber-containing sheet extending along the opposite side edges with the opposite side edges extending proximate to one another within the bottom layer from the top edge to the bottom edge, (b) a top layer comprising three separate center sheet portions of the fiber-containing sheet, each of the three separate center sheet portions being spaced from (i.e., separated from) one another within a top layer plane, the top layer plane being spaced from and extending over the bottom layer, (c) opposite side layers with each opposite side layer comprising three separate connecting sheet portions of the fiber-containing sheet, each connecting sheet portion of the three separate connecting sheet portions connecting (i) a top layer side edge of one of the three separate center sheet portions to (ii) a bottom layer side edge of the bottom layer, (d) the two openings separating the three separate center sheet portions from one another, each opening of the two openings extending along (i) the top layer, and (ii) the opposite side layers, and (e) a channel extending through the box insert profile so as to be bound by the bottom layer, the top layer, and the opposite side layers.

In another exemplary embodiment, the thermally insulating box inserts of the present invention comprises (I) a fiber-containing sheet having (i) a front surface, (ii) a rear surface, (iii) a top edge, (iv) a bottom edge, (v) opposite side edges, the opposite side edges being parallel with one another, and (vi) two openings extending from the front surface to the rear surface, and being positioned within an outer periphery of the fiber-containing sheet formed by the top edge, the bottom edge, and the opposite side edges, wherein the fiber-containing sheet is folded to form a box insert profile comprising: (a) a bottom layer comprising outer sheet portions of the fiber-containing sheet extending along the opposite side edges with the opposite side edges extending proximate to one another within the bottom layer from the top edge to the bottom edge, (b) a top layer comprising three separate center sheet portions of the fiber-containing sheet, each of the three separate center sheet portions being spaced from (i.e., separated from) one another within a top layer plane, the top layer plane being spaced from and extending over the bottom layer, (c) opposite side layers with each opposite side layer comprising three separate connecting sheet portions of the fiber-containing sheet, each connecting sheet portion of the three separate connecting sheet portions connecting (i) a top layer side edge of one of the three separate center sheet portions to (ii) a bottom layer side edge of the bottom layer, (d) the two openings separating the three separate center sheet portions from one another, each opening of the two openings extending along (i) the top layer, and (ii) the opposite side layers, and (e) a channel extending through the box insert profile so as to be bound by the bottom layer, the top layer, and the opposite side layers, and (II) one or more pieces of sheet material collectively sized to extend over and cover the two openings within the fiber-containing sheet and the box insert profile.

In yet another exemplary embodiment, the thermally insulating box inserts of the present invention comprises (I) a fiber-containing sheet having (i) a front surface, (ii) a rear surface, (iii) a top edge, (iv) a bottom edge, (v) opposite side edges, the opposite side edges being parallel with one another, and (vi) two openings extending from the front surface to the rear surface, and being positioned within an outer periphery of the fiber-containing sheet formed by the top edge, the bottom edge, and the opposite side edges, wherein the fiber-containing sheet is folded to form a box insert profile comprising: (a) a bottom layer comprising outer sheet portions of the fiber-containing sheet extending along the opposite side edges with the opposite side edges extending proximate to one another within the bottom layer from the top edge to the bottom edge, (b) a top layer comprising three separate center sheet portions of the fiber-containing sheet, each of the three separate center sheet portions being spaced from (i.e., separated from) one another within a top layer plane, the top layer plane being spaced from and extending over the bottom layer, (c) opposite side layers with each opposite side layer comprising three separate connecting sheet portions of the fiber-containing sheet, each connecting sheet portion of the three separate connecting sheet portions connecting (i) a top layer side edge of one of the three separate center sheet portions to (ii) a bottom layer side edge of the bottom layer, (d) the two openings separating the three separate center sheet portions from one another, each opening of the two openings extending along (i) the top layer, and (ii) the opposite side layers, and (e) a channel extending through the box insert profile so as to be bound by the bottom layer, the top layer, and the opposite side layers; (II) one or more pieces of sheet material collectively sized to extend over and cover the two openings within the fiber-containing sheet and the box insert profile; and (III) a plurality of insulating particles positioned within said box insert channel.

The present invention further relates to fiber-containing sheets suitable for forming a given thermally insulating box insert. In one exemplary embodiment, the fiber-containing sheet of the present invention comprises a fiber-containing sheet having (i) a front surface, (ii) a rear surface, (iii) a top edge, (iv) a bottom edge, (v) opposite side edges, the opposite side edges being parallel with one another, and (vi) two openings extending from the front surface to the rear surface, and being positioned within an outer periphery of the fiber-containing sheet formed by the top edge, the bottom edge, and the opposite side edges, wherein the fiber-containing sheet is foldable to form a box insert profile comprising: (a) a bottom layer comprising outer sheet portions of the fiber-containing sheet extending along the opposite side edges with the opposite side edges extending proximate to one another within the bottom layer from the top edge to the bottom edge, (b) a top layer comprising three separate center sheet portions of the fiber-containing sheet, each of the three separate center sheet portions being spaced from (i.e., separated from) one another within a top layer plane, the top layer plane being spaced from and extending over the bottom layer, (c) opposite side layers with each opposite side layer comprising three separate connecting sheet portions of the fiber-containing sheet, each connecting sheet portion of the three separate connecting sheet portions connecting (i) a top layer side edge of one of the three separate center sheet portions to (ii) a bottom layer side edge of the bottom layer, (d) the two openings separating the three separate center sheet portions from one another, each opening of the two openings extending along (i) the top layer, and (ii) the opposite side layers, and (e) a channel extending through the box insert profile so as to be bound by the bottom layer, the top layer, and the opposite side layers.

The present invention even further relates to insulated shipping and storage containers comprising a box and a pair of the herein-disclosed thermally insulating box inserts. In one exemplary embodiment, the insulated shipping and storage container comprises: an outer box shipping and storage container comprising at least a planar bottom wall, two sets of opposing planar side walls and at least one top panel; and two of the herein described thermally insulating box inserts, the two thermally insulating box inserts being sized so as to (1) be positioned within the outer box shipping and storage container, and (2) form an insulated cavity within the box, the insulated cavity being bound by inner surfaces of the two thermally insulating box inserts.

The present invention further relates to methods of making thermally insulating box inserts. In one exemplary embodiment, the method of making a thermally insulating box insert comprises: forming a fiber-containing sheet having (i) a front surface, (ii) a rear surface, (iii) a top edge, (iv) a bottom edge, (v) opposite side edges, the opposite side edges being parallel with one another, and (vi) two openings extending from the front surface to the rear surface, and being positioned within an outer periphery of the fiber-containing sheet formed by the top edge, the bottom edge, and the opposite side edges; and folding the fiber-containing sheet to form a box insert profile comprising: (a) a bottom layer comprising outer sheet portions of the fiber-containing sheet extending along the opposite side edges with the opposite side edges extending proximate to one another within the bottom layer from the top edge to the bottom edge, (b) a top layer comprising three separate center sheet portions of the fiber-containing sheet, each of the three separate center sheet portions being spaced from (i.e., separated from) one another within a top layer plane, the top layer plane being spaced from and extending over the bottom layer, (c) opposite side layers with each opposite side layer comprising three separate connecting sheet portions of the fiber-containing sheet, each connecting sheet portion of the three separate connecting sheet portions connecting (i) a top layer side edge of one of the three separate center sheet portions to (ii) a bottom layer side edge of the bottom layer, (d) the two openings separating the three separate center sheet portions from one another, each opening of the two openings extending along (i) the top layer, and (ii) the opposite side layers, and (e) a channel extending through the box insert profile so as to be bound by the bottom layer, the top layer, and the opposite side layers. The methods of making thermally insulating box inserts may further comprise a number of additional steps including, but not limited to, attaching the opposite side edges to one another, e.g., with tape, and positioning an insulating member, e.g., a fibrous batt, within the channel of the box insert profile.

The present invention even further relates to methods of using thermally insulating box inserts. In one exemplary embodiment, the method of using a thermally insulating box insert comprises a method of maintaining an item at a desired temperature, wherein the method comprises: positioning the item so as to be at least partially surrounded by one or more of the herein-described thermally insulating box inserts or the herein-described insulated shipping and storage containers.

These and other features and advantages of the present invention will become apparent after a review of the following detailed description of the disclosed embodiments and the appended claims.

### BRIEF DESCRIPTION OF THE FIGURES

The present invention is further described with reference to the appended figures, wherein:

FIG. 1 is a perspective view of an exemplary thermally insulating box insert (shown without an end flap);

FIG. 2 is a front view of the exemplary thermally insulating box insert shown in FIG. 1 (shown with end flaps);

FIG. 3 is a rear view of the exemplary thermally insulating box insert shown in FIG. 1;

FIG. 4 is a top view and a bottom view of the exemplary thermally insulating box insert shown in FIG. 1;

FIG. 5 is a right view and a left view of the exemplary thermally insulating box insert shown in FIG. 1;

FIG. 6 is another front view of the exemplary thermally insulating box insert shown in FIG. 2;

FIGS. 7-9 depict cross-sectional views of the exemplary thermally insulating box insert shown in FIG. 1 as viewed along lines 7-7, 8-8, and 9-9 as shown in FIG. 6;

FIG. 10 is a side view of the exemplary thermally insulating box insert shown in FIG. 2 with the outer insert portions positioned at right angles to the inner insert portion; (i.e., a use position);

FIG. 11 is a side view of an exemplary insulated shipping and storage container comprising an outer box and a pair of thermally insulating box inserts, each of the thermally insulating box inserts comprising the exemplary thermally insulating box insert shown in FIG. 2;

FIG. 12 is a fiber-containing blank that is foldable so as to form the exemplary thermally insulating box insert shown in FIG. 2;

FIG. 13 is another fiber-containing blank that is foldable so as to form an exemplary thermally insulating box insert similar to the exemplary thermally insulating box insert shown in FIG. 1 (i.e., without end flaps);

FIG. 14 is another fiber-containing blank that is foldable so as to form an exemplary thermally insulating box insert similar to the exemplary thermally insulating box insert shown in FIG. 2 except end flap portions are along opposite end sides of the blank;

FIG. 15 depicts an exemplary sheet material (e.g., a sheet of paper) that can be used to cover the two openings of (i) the exemplary thermally insulating box insert shown in FIGS. 1-2, or (ii) the two openings of the exemplary fiber-containing blanks shown in FIGS. 12-14;

FIG. 16 depicts exemplary insulating particles that can be used to fill a box insert channel within the exemplary thermally insulating box insert shown in FIGS. 1-2;

FIG. 17 depicts the exemplary insulating particles shown in FIG. 16 positioned within the box insert channel extending through the exemplary thermally insulating box insert shown in FIG. 2;

FIG. 18 depicts a cross-sectional view of the exemplary thermally insulating box insert shown in FIG. 17 as viewed along line 18-18 as shown in FIG. 17;

FIG. 19 depicts an exemplary thermally insulating pillow sized to fit within a box insert channel extending through a thermally insulating box insert of the present invention, such as the exemplary thermally insulating box insert shown in FIG. 1 with or without the sheet material shown in FIGS. 1, 3-6, 8, 15, and 17-18;

FIG. 20 depicts the exemplary thermally insulating pillow shown in FIG. 19 positioned within the box insert channel extending through the exemplary thermally insulating box insert shown in FIG. 1; and

FIG. 21 depicts a cross-sectional view of the exemplary thermally insulating box insert shown in FIG. 20 as viewed along line 21-21 as shown in FIG. 20.

### DETAILED DESCRIPTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

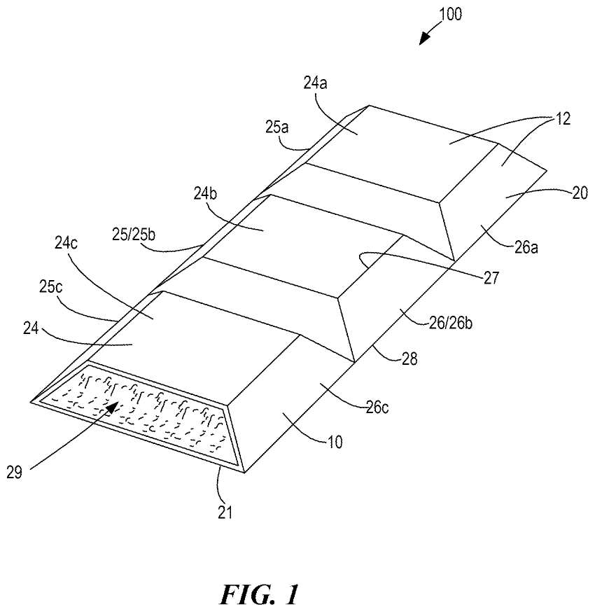

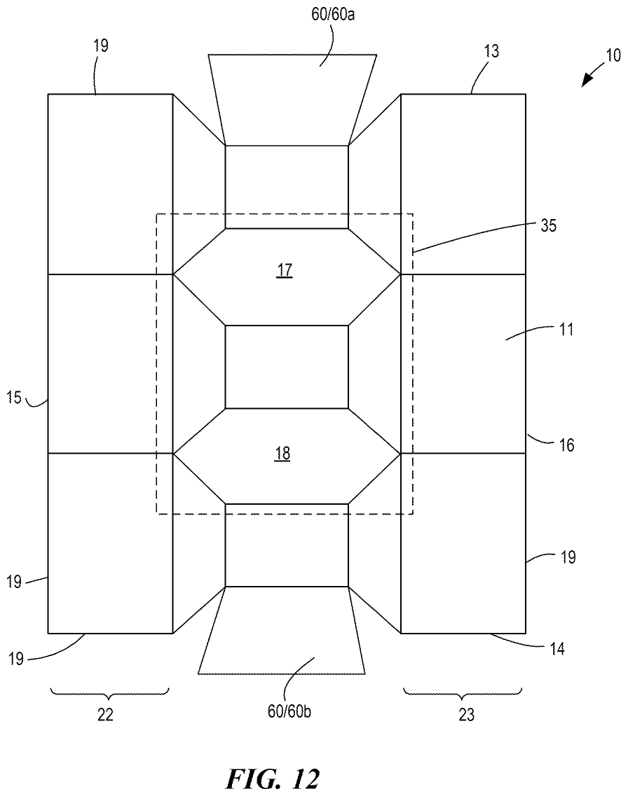

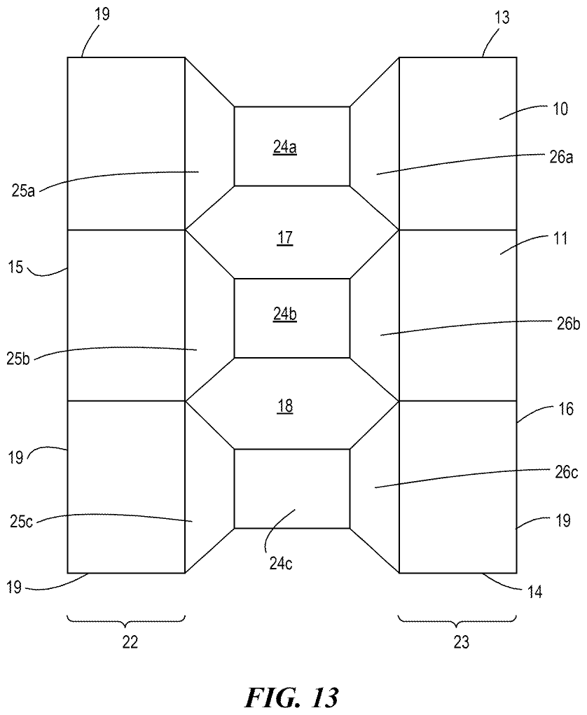

With continued reference to the drawings, the present invention will be described with respect to several embodiments for thermally insulating box inserts. As shown in FIG. 1, a thermally insulating box insert 100 of the present invention is shown. The thermally insulating box insert 100 comprises a fiber-containing sheet 10 that has been folded so as to form a box insert profile 20. As shown in FIG. 12-14, fiber-containing sheet 10 has (i) a front surface 11, (ii) a rear surface 12 (i.e., opposite front surface 11), (iii) a top edge 13, (iv) a bottom edge 14, (v) opposite side edges 15/16, with the opposite side edges 15/16 being parallel with one another, and (vi) two openings 17/18 extending from the front surface 11 to the rear surface 12, and being positioned within an outer periphery 19 of the fiber-containing sheet 10 formed by the top edge 13, the bottom edge 14, and the opposite side edges 15/16.

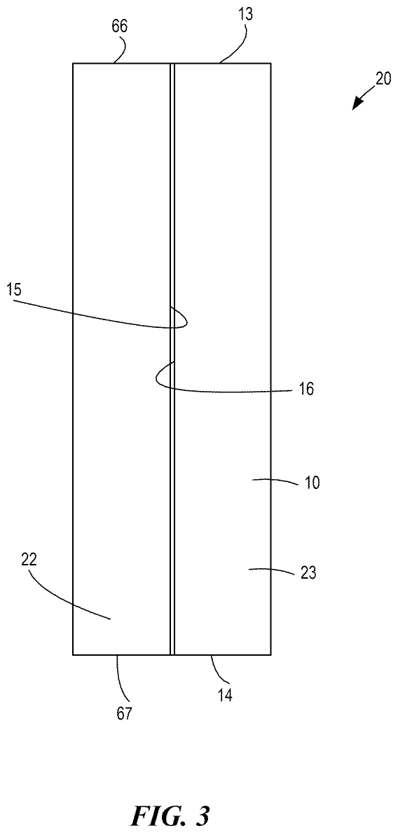

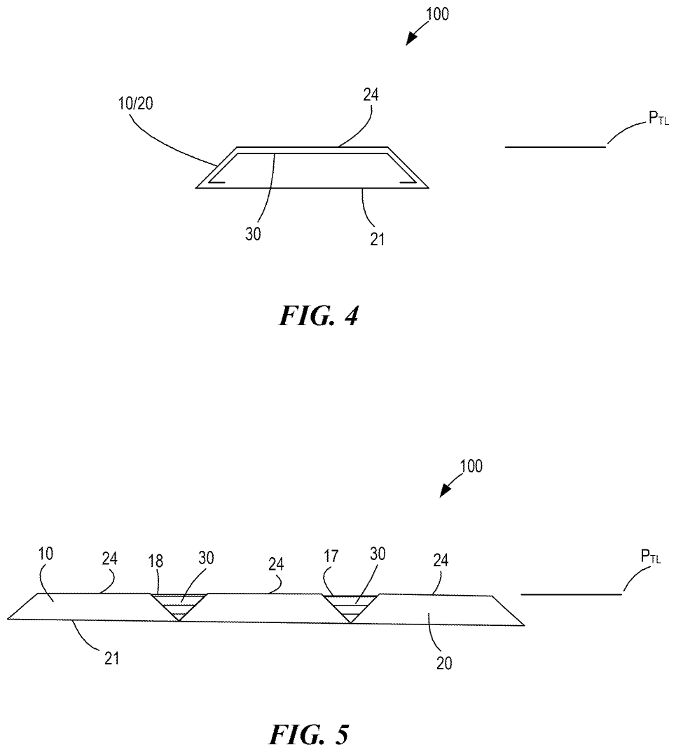

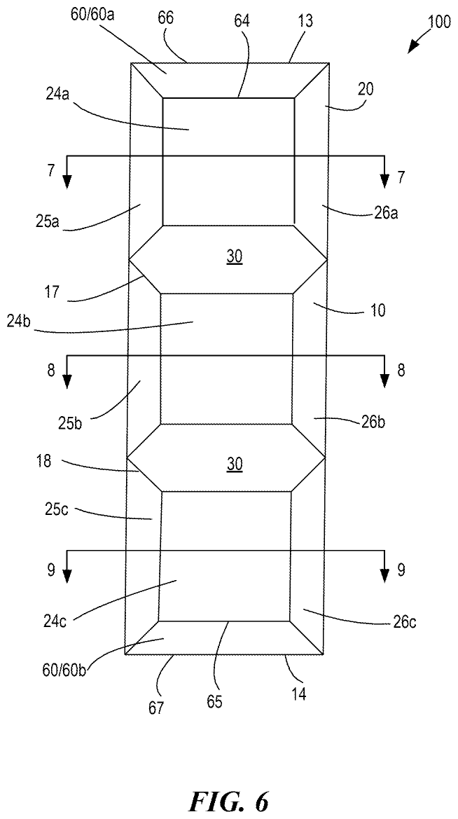

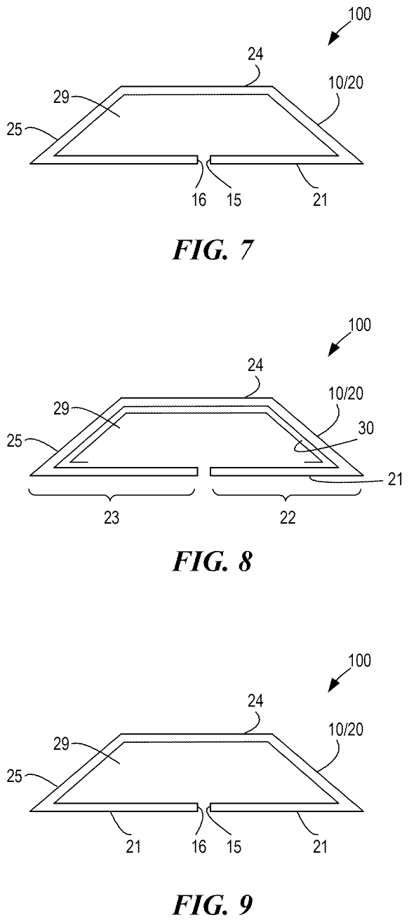

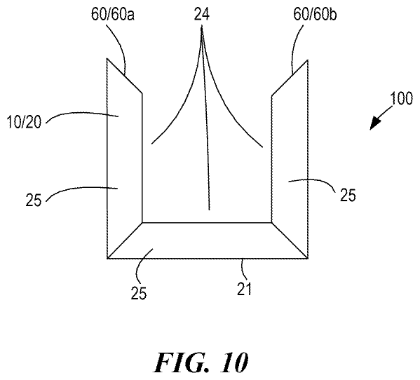

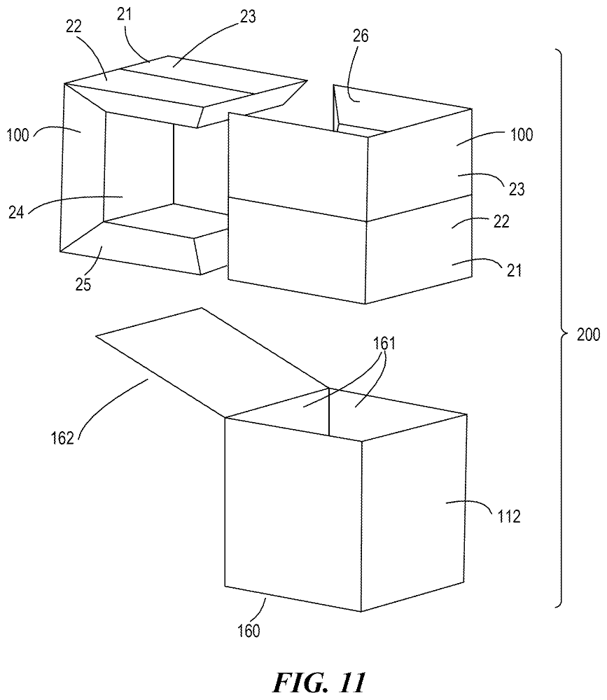

FIGS. 1-11 depict various views of the fiber-containing sheet 10 folded to form box insert profile 20. As shown in FIGS. 1-11, box insert profile 20 comprises: (a) a bottom layer 21 comprising outer sheet portions 22/23 of the fiber-containing sheet 10 extending along the opposite side edges 15/16 with the opposite side edges 15/16 extending proximate to one another within the bottom layer 21, extending from top edge 13 to bottom edge 14; (b) a top layer 24 comprising three separate center sheet portions 24a/24b/24c of the fiber-containing sheet 10, each of the three separate center sheet portions 24a/24b/24c being spaced from (i.e., separated from) one another within a top layer plane P_{TL}, wherein the top layer plane P_{TL} is spaced from and extending over the bottom layer 21, (c) opposite side layers 25/26 with each opposite side layer 25/26 comprising three separate connecting sheet portions 25a/25b/25c and 26a/26b/26c of the fiber-containing sheet 10, each connecting sheet portion of the three separate connecting sheet portions 25a/25b/25c and 26a/26b/26c connecting (i) a top layer side edge 27 of one of the three separate center sheet portions 25a/25b/25c and 26a/26b/26c to (ii) a bottom layer side edge 28 of the bottom layer 21, (d) the two openings 17/18 separating the three separate center sheet portions 24a/24b/24c from one another, each opening of the two openings 17/18 extending along (i) the top layer 24, and optionally (ii) the opposite side layers 25/26, and (e) a box insert channel 29 extending through the box insert profile 20 so as to be bound by the bottom layer 21, the top layer 24, and the opposite side layers 25/26.

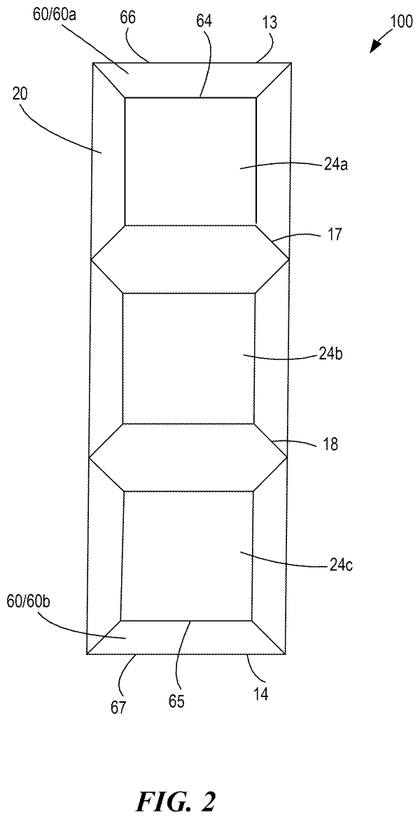

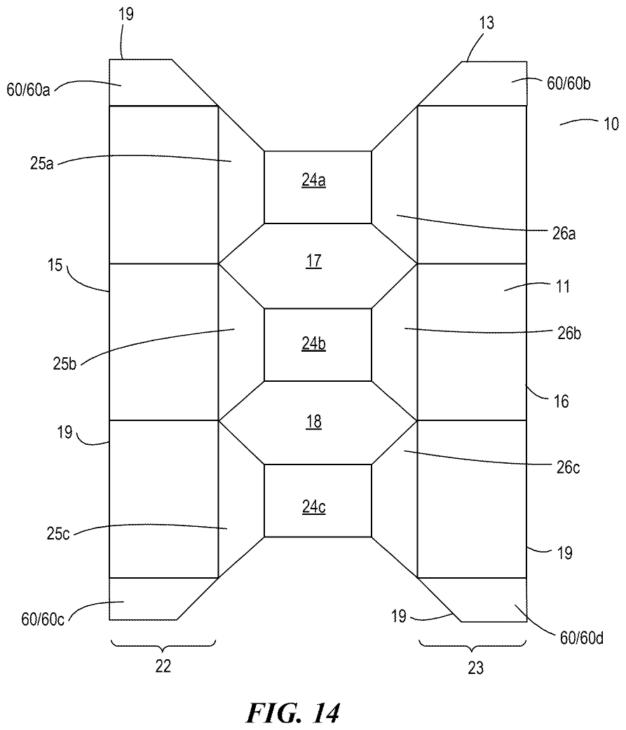

As shown in FIG. 2, thermally insulating box inserts 100 of the present invention may also comprise flaps 60 so as to enclose box insert channel 29 within box insert profile 20. As shown in FIGS. 12 and 14, flaps 60 may be end components of the top layer 24 of the box insert profile 20 or may be end components of the bottom layer 21 of the box insert profile 20.

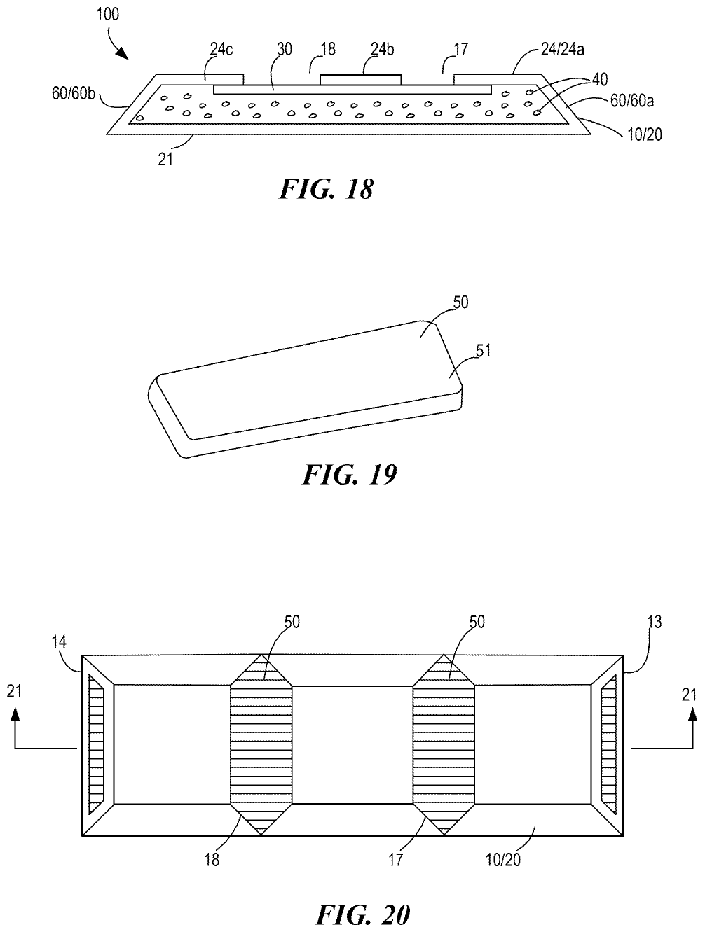

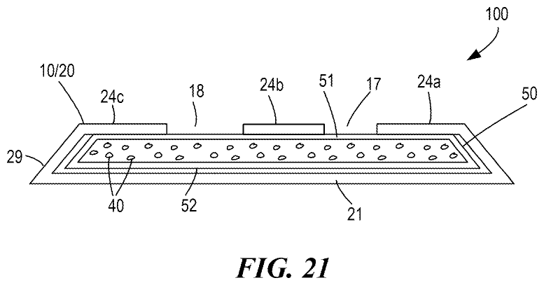

As discussed herein, thermally insulating box inserts 100 of the present invention may further comprise one or more pieces of sheet material 30 collectively sized to extend over and cover the two openings 17/18 within the fiber-containing sheet 10 and the box insert profile 20. Moreover, insulating materials, such as those shown in FIGS. 16-21, may be present within the box insert channel 29 of the box insert profile 20 as discussed below.

Thermally insulating box inserts 100 of the present invention are described throughout the present specification as comprising a fiber-containing sheet 10. However, as noted below, thermally insulating box inserts 100 of the present invention having the above-described box profile 20 could also be formed from a box profile-forming material other than a fiber-containing sheet 10. Suitable box profile-forming materials include, but are not limited to, single or multi-layer materials including corrugated plastics, corrugated recycled plastic materials for an insulated box designed for multiple uses, or combinations thereof. Desirably, the box profile-forming material can also be printed.

The (I) thermally insulating box inserts 100 of the present invention, (II) fiber-containing sheets 10 of the present invention, (III) methods of making thermally insulating box inserts 100 of the present invention, and (IV) methods of using thermally insulating box inserts 100 of the present invention, are further described in the following additional embodiments.

### Additional Embodiments

Thermally Insulating Box Inserts
1. A thermally insulating box insert 100 comprising: a fiber-containing sheet 10 having (i) a front surface 11, (ii) a rear surface 12, (iii) a top edge 13, (iv) a bottom edge 14, (v) opposite side edges 15/16, said opposite side edges 15/16 being parallel with one another, and (vi) two openings 17/18 extending from said front surface 11 to said rear surface 12, and being positioned within an outer periphery 19 of said fiber-containing sheet 10 formed by said top edge 13, said bottom edge 14, and said opposite side edges 15/16, wherein said fiber-containing sheet 10 is folded to form a box insert profile 20 comprising: a bottom layer 21 comprising outer sheet portions 22/23 of said fiber-containing sheet 10 extending along said opposite side edges 15/16 with said opposite side edges 15/16 extending proximate to one another within said bottom layer 21 from said top edge 13 to said bottom edge 14; a top layer 24 comprising three separate center sheet portions 24a/24b/24c of said fiber-containing sheet 10, each of said three separate center sheet portions 24a/24b/24c being spaced from (i.e., separated from) one another within a top layer plane P_{TL}, said top layer plane P_{TL} being spaced from and extending over said bottom layer 21, opposite side layers 25/26 with each opposite side layer 25/26 comprising three separate connecting sheet portions 25a/25b/25c and 26a/26b/26c of said fiber-containing sheet 10, each connecting sheet portion of said three separate connecting sheet portions 25a/25b/25c and 26a/26b/26c connecting (i) a top layer side edge 27 of one of said three separate center sheet portions 25a/25b/25c and 26a/26b/26c to (ii) a bottom layer side edge 28 of said bottom layer 21, said two openings 17/18 separating said three separate center sheet portions 24a/24b/24c from one another, each opening of said two openings 17/18 extending along (i) said top layer 24, and (ii) said opposite side layers 25/26, and a box insert channel 29 extending through said box insert profile 20 so as to be bound by said bottom layer 21, said top layer 24, and said opposite side layers 25/26. It should be understood that the above-described box profile 20 could be formed from a box profile-forming material other than fiber-containing sheet 10. Suitable box profile-forming materials include, but are not limited to, single or multi-layer materials including corrugated plastics, corrugated recycled plastic materials for an insulated box designed for multiple uses, or combinations thereof. Desirably, the box profile-forming material can also be printed.
2. The thermally insulating box insert 100 of embodiment 1, further comprising one or more pieces of sheet material 30 collectively sized to extend over and cover said two openings 17/18 within said fiber-containing sheet 10 and said box insert profile 20.
3. The thermally insulating box insert 100 of embodiment 1 or 2, further comprising one piece of sheet material 30 sized to extend over and cover said two openings 17/18 within said fiber-containing sheet 10 and said box insert profile 20.
4. The thermally insulating box insert 100 of embodiment 2 or 3, wherein each piece of sheet material 30 is adjacent to but not attached to said fiber-containing sheet 10.
5. The thermally insulating box insert 100 of embodiment 2 or 3, wherein each piece of sheet material 30 is adjacent to and attached to said fiber-containing sheet 10.
6. The thermally insulating box insert 100 of any one of embodiments 2 to 5, wherein each piece of sheet material 30 is positioned along (i) said front surface 11, (ii) said rear surface 12, or both of said fiber-containing sheet 10.
7. The thermally insulating box insert 100 of any one of embodiments 2 to 6, wherein each piece of sheet material 30 is positioned along said front surface 11 of said fiber-containing sheet 10. See, for example, FIG. 12 wherein dashed lines 35 are shown to indicate where one or more pieces of sheet material 30 could be positioned along front surface 11. In this embodiment, the resulting box insert profile 20 comprises one or more pieces of sheet material 30 within the box insert channel 29.
8. The thermally insulating box insert 100 of any one of embodiments 2 to 7, wherein each piece of sheet material 30 is positioned along (not shown) said rear surface 12 of said fiber-containing sheet 10. In this embodiment, the resulting box insert profile 20 comprises one or more pieces of sheet material 30 along said top layer 24, typically, along said top layer 24, and said opposite side layers 25/26.
9. The thermally insulating box insert 100 of any one of embodiments 2 to 8, wherein said one or more pieces of sheet material 30 collectively has a sheet material length L_{SM} that is equal to or less than a distance between said top edge 13 and said bottom edge 14. It should be understood that the distance between said top edge 13 and said bottom edge 14 may be any desired distance (e.g., from 18 inches (in) to 270 in).
10. The thermally insulating box insert 100 of any one of embodiments 2 to 9, wherein said one or more pieces of sheet material 30 collectively has a sheet material length L_{SM} that is less than a distance between from said top edge 13 and said bottom edge 14.
11. The thermally insulating box insert 100 of any one of embodiments 2 to 10, wherein each piece of sheet material 30 independently has a sheet material width W_{SM} that is (i) equal to or greater than a width of said two openings 17/18, and (ii) equal to or less than a distance between said opposite side edges 15/16 of said fiber-containing sheet 10. It should be understood that the distance between said opposite side edges 15/16 may be any desired distance (e.g., from 18 inches (in) to 270 in).
12. The thermally insulating box insert 100 of any one of embodiments 2 to 11, wherein each piece of sheet material 30 independently has a sheet material width W_{SM} that is (i) greater than a width of said two openings 17/18, and (ii) less than a distance between said opposite side edges 15/16 of said fiber-containing sheet 10.
13. The thermally insulating box insert 100 of any one of embodiments 2 to 12, wherein each piece of sheet material 30 comprises a sheet of paper.
14. The thermally insulating box insert 100 of any one of embodiments 1 to 13, further comprising a plurality of insulating loose fill materials 40 positioned within said box insert channel 29. Suitable insulating loose fill materials 40 include, but are not limited to, water soluble starch-based packing peanuts, bio-based cellulosic fibers such as cotton, hemp fibers, and wood fibers, strips of light weight paper (e.g., what comes out of an office shredder), paper fibers (e.g., same as is used in blown insulation), shredded polyurethane foam, and any combination thereof. Alternatively, or in addition to the insulating loose fill materials 40, other insulation materials 40/50/52 may be used including insulation materials other than insulating loose fill materials 40. Other insulation materials 50/52 may include, but are not limited to, flexible laminated insulation materials (e.g., insulation materials embedded within a matrix material, e.g., a foam); paper batt insulation; multi-layer light weight paper/crepe paper (e.g., the insulation described in PCT Patent Application Serial No. PCT/US2022/028263, the subject matter of which is hereby incorporated by reference in its entirety); cotton, jute hemp or paper based non-woven insulation batt; air filled bags; polyurethane foam; or any combination thereof.
15. The thermally insulating box insert 100 of embodiment 14, wherein said plurality of insulating loose fill materials 40 comprise water soluble starch-based packing peanuts, paper fibers, or any combination thereof.
16. The thermally insulating box insert 100 of any one of embodiments 1 to 13, further comprising a thermally insulating pillow 50 positioned within said box insert channel 29.
17. The thermally insulating box insert 100 of embodiment 16, wherein said thermally insulating pillow 50 comprises (a) an outer shell 51 and (b)(i) a plurality of insulating particles 40 or (ii) any other type of insulation 52 (e.g., one or more foam layers, one or more paper layers, one or more of the components described in embodiment 14 above, etc.) within the outer shell 51.
18. The thermally insulating box insert 100 of any one of embodiments 1 to 17, wherein said fiber-containing sheet 10 further comprises flaps 60 at said top edge 13, and said bottom edge 14, said flaps 60 being sized, configured, and foldable to cover insert end openings 61/61 at one end 62 or both ends 62/63 of said box insert channel 29.
19. The thermally insulating box insert 100 of embodiment 18, wherein said flaps 60 (i) comprise two flaps 60a/60b, (ii) are within said top layer 24 of said box profile 20, and (iii) are at opposite ends 64/65 of said top layer 24. See, for example, FIG. 12.
20. The thermally insulating box insert 100 of embodiment 18, wherein said flaps 60 (i) comprise four flaps 60a/60b/60c/60d, (ii) are within said bottom layer 21 of said box profile 20, and (iii) are at opposite ends 66/67 of bottom layer 21 of said box profile 20. See, for example, FIG. 14.
21. The thermally insulating box insert 100 of any one of embodiments 1 to 20, wherein said fiber-containing sheet 10 comprises a corrugated fiberboard sheet.
22. The thermally insulating box insert 100 of any one of embodiments 1 to 21, wherein said fiber-containing sheet 10 comprises a multi-layer corrugated cardboard with 32 lbs/square in crush weight with F or E type flute, and high content (e.g., more than 10 wt %) of recycled fibers. Lighter or heavier weight cardboard could be used depending on how much weight the assembled insulating structure will be designed to hold.

Fiber-Containing Sheets for Forming Thermally Insulating Box Inserts
23. The fiber-containing sheet 10 used to form the box insert profile 20 described in any one of embodiments 1 to 22 above.
24. A fiber-containing sheet 10 having (i) a front surface 11, (ii) a rear surface 12, (iii) a top edge 13, (iv) a bottom edge 14, (v) opposite side edges 15/16, said opposite side edges 15/16 being parallel with one another, and (vi) two openings 17/18 extending from said front surface 11 to said rear surface 12, and being positioned within an outer periphery 19 of said fiber-containing sheet 10 formed by said top edge 13, said bottom edge 14, and said opposite side edges 15/16, wherein said fiber-containing sheet 10 is foldable to form a thermally insulating box insert 100 having a box insert profile 20 comprising: a bottom layer 21 comprising outer sheet portions 22/23 of said fiber-containing sheet 10 extending along said opposite side edges 15/16 with said opposite side edges 15/16 extending proximate to one another within said bottom layer 21 from said top edge 13 to said bottom edge 14; a top layer 24 comprising three separate center sheet portions 24a/24b/24c of said fiber-containing sheet 10, each of said three separate center sheet portions 24a/24b/24c being spaced from (i.e., separated from) one another within a top layer plane P_{TL}, said top layer plane P_{TL} being spaced from and extending over said bottom layer 21, opposite side layers 25/26 with each opposite side layer 25/26 comprising three separate connecting sheet portions 25a/25b/25c and 26a/26b/26c of said fiber-containing sheet 10, each connecting sheet portion of said three separate connecting sheet portions 25a/25b/25c and 26a/26b/26c connecting (i) a top layer side edge 27 of one of said three separate center sheet portions 25a/25b/25c and 26a/26b/26c to (ii) a bottom layer side edge 28 of said bottom layer 21, said two openings 17/18 separating said three separate center sheet portions 24a/24b/24c from one another, each opening of said two openings 17/18 extending along (i) said top layer 24, and (ii) said opposite side layers 25/26, and a box insert channel 29 extending through said box insert profile 20 so as to be bound by said bottom layer 21, said top layer 24, and said opposite side layers 25/26.
25. The fiber-containing sheet 10 of embodiment 24, wherein said fiber-containing sheet 10 further comprises flaps 60 at said top edge 13, and said bottom edge 14, said flaps 60 being sized, configured, and foldable to cover insert end openings 61/61 at one end 62 or both ends 62/63 of said box insert channel 29.
26. The fiber-containing sheet 10 of embodiment 25, wherein said flaps 60 (i) comprise two flaps 60a/60b, (ii) are within said top layer 24 of said box profile 20, and (iii) are at opposite ends 64/65 of said top layer 24. See, for example, FIG. 12.
27. The fiber-containing sheet 10 of embodiment 25, wherein said flaps 60 (i) comprise four flaps 60a/60b/60c/60d, (ii) are within said bottom layer 21 of said box profile 20, and (iii) are at opposite ends 66/67 of bottom layer 21 of said box profile 20. See, for example, FIG. 14.
28. The fiber-containing sheet 10 of any one of embodiments 24 to 27, wherein said fiber-containing sheet 10 comprises a corrugated fiberboard sheet.
29. The fiber-containing sheet 10 of any one of embodiments 24 to 28, wherein said fiber-containing sheet 10 comprises a multi-layer corrugated cardboard with 32 lbs/square in crush weight with F or E type flute, and high content (e.g., more than 10 wt %) of recycled fibers.
30. The fiber-containing sheet 10 of any one of embodiments 24 to 29, in combination with the one or more pieces of sheet material 30 described in any one of embodiments 2 to 13.
31. The fiber-containing sheet 10 of any one of embodiments 24 to 30, in combination with the plurality of insulating particles 40 described in embodiment 14 or 15.
32. The fiber-containing sheet 10 of any one of embodiments 24 to 31, in combination with the thermally insulating pillow 50 described in embodiment 16 or 17.

Insulated Shipping and Storage Containers
33. An insulated shipping and storage container 200 comprising: an outer box shipping and storage container 112 comprising at least a planar bottom wall 160, two sets of opposing planar side walls 161 and at least one top panel 162; and two box inserts, each box insert comprising the thermally insulating box insert 100 of any one of embodiments 1 to 22.
34. The insulated shipping and storage container 200 of embodiment 33, wherein the two box inserts 100 are positioned within the outer box shipping and storage container 112.
35. The insulated shipping and storage container 200 of embodiment 33 or 34, wherein the insulated shipping and storage container 200 is repulpable.

Methods of Making Thermally Insulating Box Inserts
36. A method of making the thermally insulating box insert 100 of any one of embodiments 1 to 22, or the fiber-containing sheet 10 of any one of embodiments 23 to 32, said method comprising: forming a fiber-containing sheet 10 having (i) a front surface 11, (ii) a rear surface 12, (iii) a top edge 13, (iv) a bottom edge 14, (v) opposite side edges 15/16, the opposite side edges 15/16 being parallel with one another, and (vi) two openings 17/18 extending from the front surface 11 to the rear surface 12, and being positioned within an outer periphery 19 of the fiber-containing sheet 10 formed by the top edge 13, the bottom edge 14, and the opposite side edges 15/16; and folding the fiber-containing sheet 10 to form a box insert profile 20 comprising: a bottom layer 21 comprising outer sheet portions 22/23 of the fiber-containing sheet 10 extending along the opposite side edges 15/16 with the opposite side edges 15/16 extending proximate to one another within the bottom layer 21 from the top edge 13 to the bottom edge 14; a top layer 24 comprising three separate center sheet portions 24a/24b/24c of the fiber-containing sheet 10, each of the three separate center sheet portions 24a/24b/24c being spaced from (i.e., separated from) one another within a top layer plane P_{TL}, the top layer plane P_{TL} being spaced from and extending over the bottom layer 21, opposite side layers 25/26 with each opposite side layer 25/26 comprising three separate connecting sheet portions 25a/25b/25c and 26a/26b/26c of the fiber-containing sheet 10, each connecting sheet portion of the three separate connecting sheet portions 25a/25b/25c and 26a/26b/26c connecting (i) a top layer side edge 27 of one of the three separate center sheet portions 25a/25b/25c and 26a/26b/26c to (ii) a bottom layer side edge 28 of the bottom layer 21, the two openings 17/18 separating the three separate center sheet portions 24a/24b/24c from one another, each opening of the two openings 17/18 extending along (i) the top layer 24, and (ii) the opposite side layers 25/26, and a box insert channel 29 extending through the box insert profile 20 so as to be bound by the bottom layer 21, the top layer 24, and the opposite side layers 25/26.
37. The method of embodiment 36, wherein said forming step comprises one or more of: a fiberboard forming step, a fiberboard cutting step, and a fiberboard die-cutting step.
38. The method of embodiment 36 or 37, further comprising: attaching the opposite side edges 15/16 to one another.
39. The method of any one of embodiments 36 to 38, further comprising: positioning one or more pieces of sheet material 30 over the two openings 17/18 within the fiber-containing sheet 10 to cover the two openings 17/18 within the fiber-containing sheet 10.
40. The method of embodiment 39, wherein said positioning step does not attached the one or more pieces of sheet material 30 to the fiber-containing sheet 10.
41. The method of embodiment 39, wherein said positioning step does attached the one or more pieces of sheet material 30 to the fiber-containing sheet 10.
42. The method of any one of embodiments 36 to 41, further comprising: positioning insulation 40/50 within the channel 29 of the box insert profile 20.
43. The method of embodiment 42, wherein the insulation 40/50 comprises the plurality of insulating particles 40 described in embodiment 14 or 15.
44. The method of embodiment 42, wherein the insulation 40/50 comprises the thermally insulating pillow 50 described in embodiment 16 or 17.

Methods of Using Thermally Insulating Box Inserts
45. A method of maintaining an item (not shown) at a desired temperature, said method comprising: surrounding the item with a pair of box inserts, each of the box inserts comprising the thermally insulating box insert 100 of any one of embodiments 1 to 22.
46. The method of embodiment 45, further comprising: positioning the pair of box inserts 100/100 within a box 112.
47. The method of embodiment 45 or 46, wherein the item comprises a food item, medicine, blood, a body organ, or any combination thereof.

It should be understood that although the above-described thermally insulating box inserts 100, fiber-containing sheets 10, and methods are described as “comprising” one or more features, components or steps, the above-described thermally insulating box inserts 100, fiber-containing sheets 10, and methods may “comprise,” “consists of,” or “consist essentially of” any of the above-described features, components or steps of the thermally insulating box inserts 10, fiber-containing sheets, and methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a thermally insulating box insert 100, a fiber-containing sheet 10, and/or a method that “comprises” a list of elements (e.g., components or steps) is not necessarily limited to only those elements (or components or steps), but may include other elements (or components or steps) not expressly listed or inherent to the thermally insulating box insert 100, the fiber-containing sheet 10, and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a thermally insulating box insert 100, a fiber-containing sheet 10, and/or a method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described thermally insulating box inserts 100, fiber-containing sheets 10, and/or methods may comprise, consist essentially of, or consist of any of the herein-described components, features, and steps, as shown in the figures with or without any feature(s) not shown in the figures. In other words, in some embodiments, the thermally insulating box inserts 100, fiber-containing sheets 10, and/or methods of the present invention do not have any additional features other than those shown in the figures, and such additional features, not shown in the figures, are specifically excluded from the thermally insulating box inserts 100, fiber-containing sheets 10, and/or methods. In other embodiments, the thermally insulating box inserts 100, fiber-containing sheets 10, and/or methods of the present invention do have one or more additional features that are not shown in the figures.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

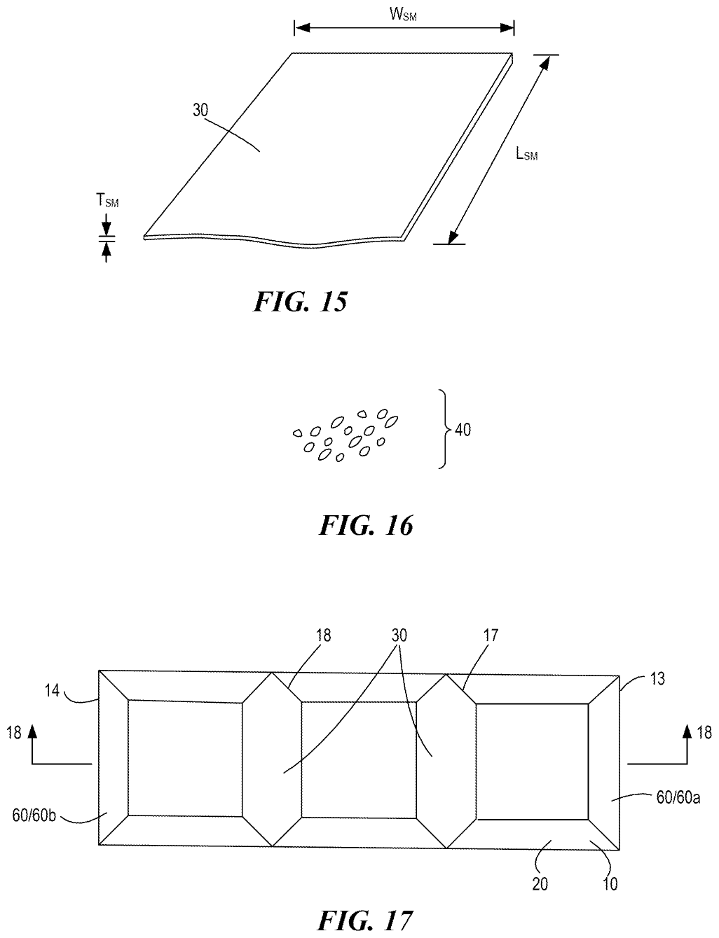

Thermally insulating box inserts 100, and fiber-containing sheets 10 as described in embodiments 1 to 35, and shown in FIGS. 1-21 were prepared. The thermally insulating box inserts 100 were used to line cardboard boxes 112 and provide thermal insulation of various products (e.g., medicines, foods, etc.) surrounded by the thermally insulating box inserts 100.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. A thermally insulating box insert comprising:
a fiber-containing sheet having (i) a front surface, (ii) a rear surface, (iii) a top edge, (iv) a bottom edge, (v) opposite side edges, said opposite side edges being parallel with one another, and (vi) two openings extending from said front surface to said rear surface, and being positioned within an outer periphery of said fiber-containing sheet formed by said top edge, said bottom edge, and said opposite side edges,
wherein said fiber-containing sheet is folded to form a box insert profile comprising:
a bottom layer comprising outer sheet portions of said fiber-containing sheet extending along said opposite side edges with said opposite side edges extending proximate to one another within said bottom layer from said top edge to said bottom edge;
a top layer comprising three separate center sheet portions of said fiber-containing sheet, each of said three separate center sheet portions being spaced from (i.e., separated from) one another within a top layer plane, said top layer plane being spaced from and extending over said bottom layer,
opposite side layers with each opposite side layer comprising three separate connecting sheet portions of said fiber-containing sheet, each connecting sheet portion of said three separate connecting sheet portions connecting (i) a top layer side edge of one of said three separate center sheet portions to (ii) a bottom layer side edge of said bottom layer,
said two openings separating said three separate center sheet portions from one another, each opening of said two openings extending along (i) said top layer, and (ii) said opposite side layers, and
a box insert channel extending through said box insert profile so as to be bound by said bottom layer, said top layer, and said opposite side layers.

2. The thermally insulating box insert of claim 1, further comprising one or more pieces of sheet material collectively sized to extend over and cover said two openings within said fiber-containing sheet and said box insert profile.

3-12. (canceled)

13. The thermally insulating box insert of claim 2, wherein each piece of sheet material comprises a sheet of paper.

14. The thermally insulating box insert of claim 2, further comprising a plurality of insulating loose fill materials positioned within said box insert channel.

15. The thermally insulating box insert of claim 14, wherein said plurality of insulating loose fill materials comprise water soluble starch-based packing peanuts, paper fibers, or any combination thereof.

16. The thermally insulating box insert of claim 1, further comprising a thermally insulating pillow positioned within said box insert channel.

17. The thermally insulating box insert of claim 16, wherein said thermally insulating pillow comprises (a) an outer shell and (b)(i) a plurality of insulating particles or (ii) any other type of insulation within the outer shell.

18. The thermally insulating box insert of claim 1, wherein said fiber-containing sheet further comprises flaps at said top edge, and said bottom edge, said flaps being sized, configured, and foldable to cover insert end openings at one end or both ends of said box insert channel.

19. The thermally insulating box insert of claim 18, wherein said flaps (i) comprise two flaps, (ii) are within said top layer of said box profile, and (iii) are at opposite ends of said top layer.

20. The thermally insulating box insert of claim 18, wherein said flaps (i) comprise four flaps, (ii) are within said bottom layer of said box profile, and (iii) are at opposite ends of said top layer.

21. The thermally insulating box insert of claim 1, wherein said fiber-containing sheet comprises a corrugated fiberboard sheet.

22. (canceled)

23. The fiber-containing sheet used to form the box insert profile described in claim 1 above.

24. A fiber-containing sheet having (i) a front surface, (ii) a rear surface, (iii) a top edge, (iv) a bottom edge, (v) opposite side edges, said opposite side edges being parallel with one another, and (vi) two openings extending from said front surface to said rear surface, and being positioned within an outer periphery of said fiber-containing sheet formed by said top edge, said bottom edge, and said opposite side edges,
wherein said fiber-containing sheet is foldable to form a thermally insulating box insert having a box insert profile comprising:
a bottom layer comprising outer sheet portions of said fiber-containing sheet extending along said opposite side edges with said opposite side edges extending proximate to one another within said bottom layer from said top edge to said bottom edge;
a top layer comprising three separate center sheet portions of said fiber-containing sheet, each of said three separate center sheet portions being spaced from (i.e., separated from) one another within a top layer plane, said top layer plane being spaced from and extending over said bottom layer,
opposite side layers with each opposite side layer comprising three separate connecting sheet portions of said fiber-containing sheet, each connecting sheet portion of said three separate connecting sheet portions connecting (i) a top layer side edge of one of said three separate center sheet portions to (ii) a bottom layer side edge of said bottom layer,
said two openings separating said three separate center sheet portions from one another, each opening of said two openings extending along (i) said top layer, and (ii) said opposite side layers, and
a channel extending through said box insert profile so as to be bound by said bottom layer, said top layer, and said opposite side layers.

25. The fiber-containing sheet of claim 24, wherein said fiber-containing sheet further comprises flaps at said top edge, and said bottom edge, said flaps being sized, configured, and foldable to cover insert end openings at one end or both ends of said box insert channel.

26. The fiber-containing sheet of claim 25, wherein said flaps (i) comprise two flaps, (ii) are within said top layer of said box profile, and (iii) are at opposite ends of said top layer.

27. The fiber-containing sheet of claim 25, wherein said flaps (i) comprise four flaps, (ii) are within said bottom layer of said box profile, and (iii) are at opposite ends of said top layer.

28-32. (canceled)

33. An insulated shipping and storage container comprising:
an outer box shipping and storage container comprising at least a planar bottom wall, two sets of opposing planar side walls and at least one top panel; and
two box inserts, each box insert comprising the thermally insulating box insert of claim 1.

34. The insulated shipping and storage container of claim 33, wherein the two box inserts are positioned within the outer box shipping and storage container.

35. (canceled)

36. A method of making the thermally insulating box insert of claim 1, said method comprising:
forming a fiber-containing sheet having (i) a front surface, (ii) a rear surface, (iii) a top edge, (iv) a bottom edge, (v) opposite side edges, the opposite side edges being parallel with one another, and (vi) two openings extending from the front surface to the rear surface, and being positioned within an outer periphery of the fiber-containing sheet formed by the top edge, the bottom edge, and the opposite side edges; and
folding the fiber-containing sheet to form a box insert profile comprising: (a) a bottom layer comprising outer sheet portions of the fiber-containing sheet extending along the opposite side edges with the opposite side edges extending proximate to one another within the bottom layer from the top edge to the bottom edge, (b) a top layer comprising three separate center sheet portions of the fiber-containing sheet, each of the three separate center sheet portions being spaced from (i.e., separated from) one another within a top layer plane, the top layer plane being spaced from and extending over the bottom layer, (c) opposite side layers with each opposite side layer comprising three separate connecting sheet portions of the fiber-containing sheet, each connecting sheet portion of the three separate connecting sheet portions connecting (i) a top layer side edge of one of the three separate center sheet portions to (ii) a bottom layer side edge of the bottom layer, (d) the two openings separating the three separate center sheet portions from one another, each opening of the two openings extending along (i) the top layer, and (ii) the opposite side layers, and (e) a channel extending through the box insert profile so as to be bound by the bottom layer, the top layer, and the opposite side layers.

37-44. (canceled)

45. A method of maintaining an item (not shown) at a desired temperature, said method comprising:
surrounding the item with a pair of box inserts, each of the box inserts comprising the thermally insulating box insert of claim 1.

46-47. (canceled)
